(19) United States
(12) Patent Application Publication
(10) Pub. No.: US 2015/0375109 A1
(43) Pub. Date: Dec. 31, 2015

(54) Method of Integrating Ad Hoc Camera Networks in Interactive Mesh Systems

(71) Applicant: Matthew E. Ward, Philadelphia, PA (US)

(72) Inventor: Matthew E. Ward, Philadelphia, PA (US)

(21) Appl. No.: 14/846,153

(22) Filed: Sep. 4, 2015

Related U.S. Application Data
(63) Continuation-in-part of application No. 13/190,995, filed on Jul. 26, 2011, now abandoned.
(60) Provisional application No. 61/400,314, filed on Jul. 26, 2010.

(51) Int. Cl. A63F 13/25; G06T 19/00

(52) U.S. Cl. CPC A63F 13/25; G06T 19/006

(57) ABSTRACT

An entertainment system has a first recording device that records digital images, a server that receives the images from the first device, wherein the second device, based on data from another source, enhances the images from the first device for display.

### FIELD OF INVENTION

This relates to sensor systems used in smartphones and networked cameras and methods to mesh multiple camera feeds.

### BACKGROUND

Systems such as Flickr, Photosynth, Seadragon, and Historypin work with modern networked cameras (including cameras in phones) to allows for much greater sharing and shared power. Social networks that use location such 4 square are also well known. Sharing digital images and videos, and creating digital environments from these, is a new digital frontier.

### SUMMARY

This disclosure describes a system that incorporates multiple sources of information to automatically create a 3D wireframe of an event that may be used later by multiple spectators to watch the event at home with substantially expanded viewing options.

An entertainment system has a first recording device that records digital images, a server that receives the images from the first device, wherein the second device, based on data from another source, enhances the images from the first device for display.

### BRIEF DESCRIPTION OF THE DRAWINGS

FIG. 1 illustrates a smart device application and system diagram.

FIG. 2 illustrates multiple smartphones as a sensor mesh.

FIG. 3 illustrates phone users tracking action on field.

FIG. 4 illustrates using network feedback to improve image.

FIG. 5 illustrates smartphone sensors used in the application.

FIG. 6 illustrates smartphone sensors and sound.

FIG. 7 shows a 3D space.

FIG. 8 illustrates alternate embodiments.

FIG. 9 illustrates video frame management.

FIG. 10 illustrates a mesh construction.

FIG. 11 illustrates avatar creation.

FIG. 12 illustrates supplemental information improving an avatar.

FIG. 13 shows an avatar point-of-view.

FIG. 14 shows data flow in the system.

### DETAILED DESCRIPTION OF THE PREFERRED EMBODIMENTS

### Introduction

Time of Flight (ToF) cameras, and similar realtime 3D mapping technologies may be used in social digital imaging because they allow a detailed point cloud of vertices that represent individuals in the space to be mapped as three dimensional objects, in much the same way that sonar is used to map underwater geography. Phone and camera makers are using ToF and similar sensors to bring greater fidelity to 3D images.

In addition, virtual sets, avatars, photographic databases, video content, spatial audio, point clouds, and other graphical and digital content enables a medium that blurs the space between real world documentation, like traditional photography, and virtual space, like video games. Consider, for example, the change from home brochures to online home video tours.

The combination of virtual set and character, multiple video sources, location-tagged image and media databases, and 3 dimensional vertex data may combine to create a new medium in which it is possible to literally see around corners, interpolating data that was unable to record and blending it with other content available in the cloud, or within the user's own sensor based data. The combination of this content will blend video games and reality in a seamless way.

Using this varied content, viewers will be able to see content that was never recorded in the traditional sense of recording optically visual data. An avatar of a soccer player might be textured using data from multiple cameras and 3D data from other users. The playing field might be made up of stitched together pieces of Flikr photographs. Dirt and grass might become textures on 3D models captured from a database.

One of the benefits of this new medium is the ability to place the user in places where cameras weren't placed, for instance, at the level of the ball in the middle of the field.

The density of location-based data should substantially increase over the next decade as companies develop next-generation standards and geocaching becomes automated. In the soccer example above, people's phones and wallets, and even the soccer ball, may send location-based data to enhance the accuracy of the system.

The use of data recombination and filtering to create 3D virtual representations has other connotations as well. After the game, players may explore alternate plays by assigning an artificial intelligence (AI) to the opposing teams players and seeing how they react differently to different player positions and passing strategies.

### DESCRIPTION

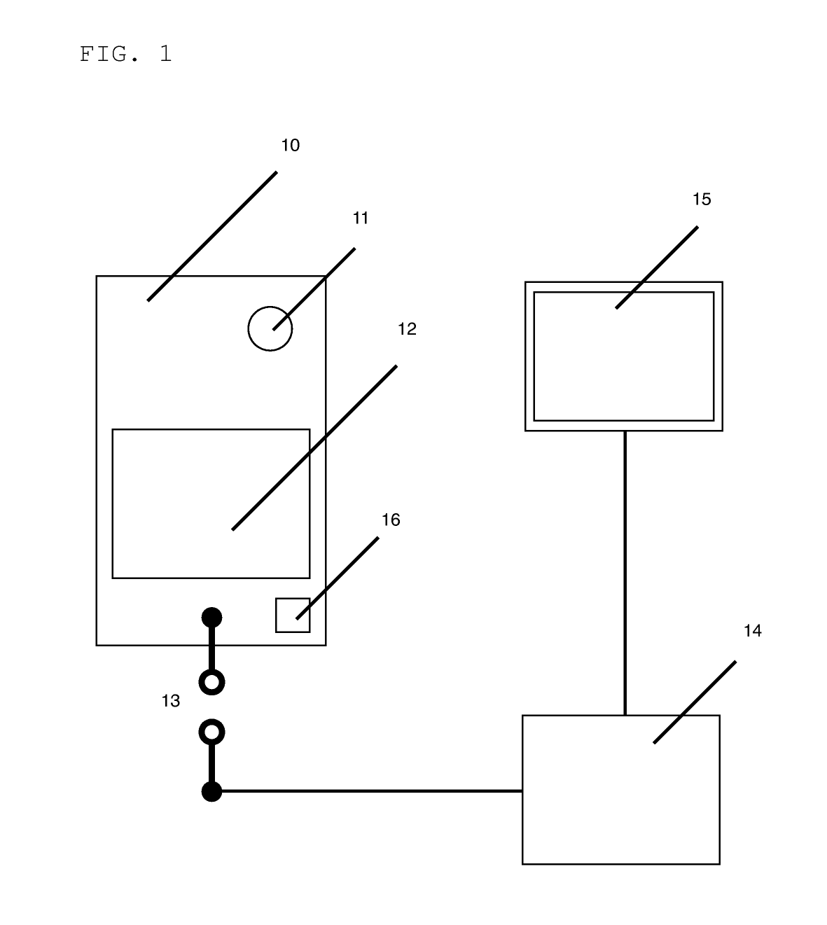

FIG. 1 illustrates a single element of the larger sensor mesh. A digital recording device 10 contains a camera 11 and internal storage 12. The device connects to a wired or wireless network 13. The network 13 may feed a server 14 where video from the device 10 can be processed and delivered to a network enabled local monitor 15 or entertainment projection room. This feed may be viewed in multiple locations. Users can comment on the feed and potentially add their own media. The feed can also contain additional information from other digital sensing data sensors 16 in the device 10. These sensors 16 may include GPS, accelerometer, microphone, light sensors, and gyroscopes. All of this information can be processed in a data center with a high degree of efficiency and this creates new options for software.

The feed from the smart device 10 may be optimized for streaming through compression and it is possible to transmit the data more efficiently using more application specific network protocols. But the sensor networks may be able to use multiple feeds from a single location to create a more complete playback scenario. If the optimized network protocol includes metadata from sensors as well as a network time code, then it is possible to integrate multiple feeds offline when network and processor demand is lower. If the streaming video codec includes full resolution frames that include edge detection, contrast, and motion information, along with the smaller frames for network streaming, then this information can be used to quickly build multiple feeds into a single optimized vertex based wireframe similar to what might be used in a video game. In this scenario, the cameras/devices 10 fill the role of a motion capture system.

The system may include the appropriate software at the smart device level, the system level, and the home computer level. It may also be necessary to have software or a plugin for network-enabled devices such as video game platforms or network-enabled televisions 15. Furthermore, it is possible for a network-enabled camera to provide much of this functionality and the words Smartphone, Smart Device, and Network Enabled Camera are used interchangably where it relates to the streaming of content to the web.

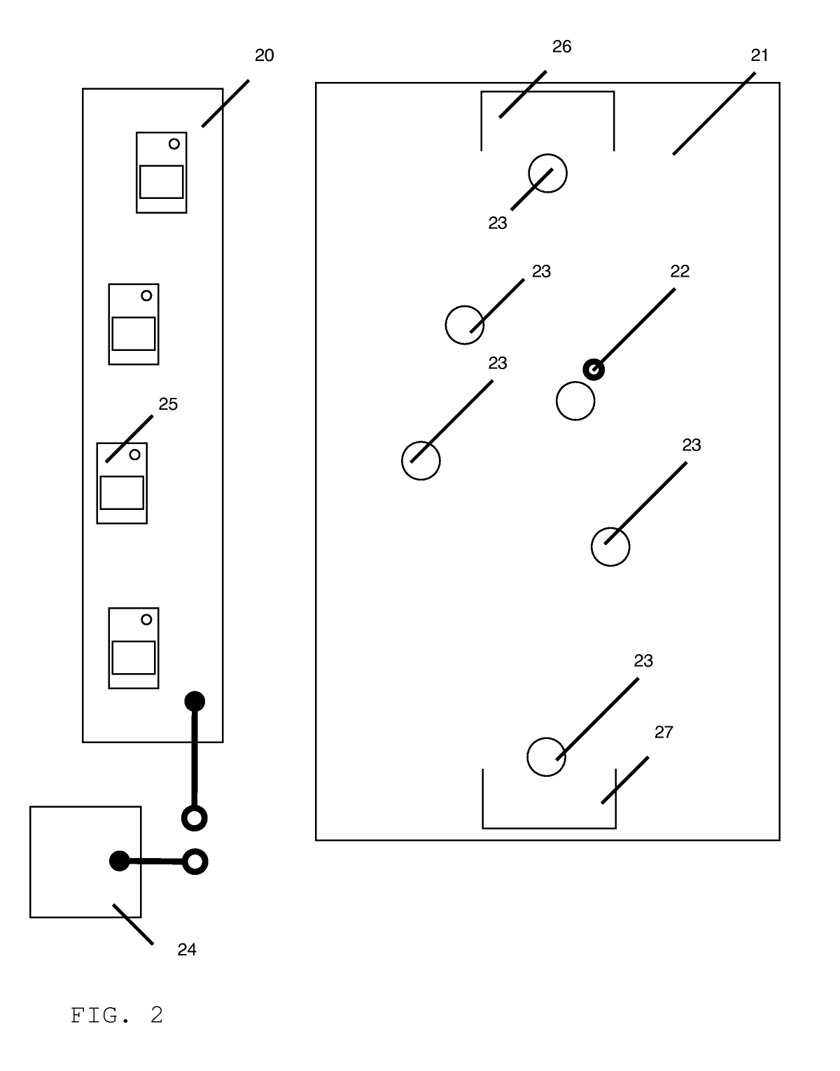

FIG. 2 illustrates multiple smartphones 20 used by spectators/users watching a soccer game 21. These phones 20 are in multiple locations along the field. All the phones may use an installed application to stream data to a central server 24. In this instance the spectators may be most interested in the players 23 but the action may tend to follow the ball 22.

To configure the cameras for a shared event capture, a user 25 might perform a specific task in the application software such as aligning the goal at one end of the field 26 with a marker in the application and then panning the camera to the other goal 27 and aligning that goal with a marker in the application. This information helps define the other physical relationships on the field. The configuration may also involve taking pictures of the players tracked in the game. Numbers and other prominent features can be used in the software to name and identify players later in the process.

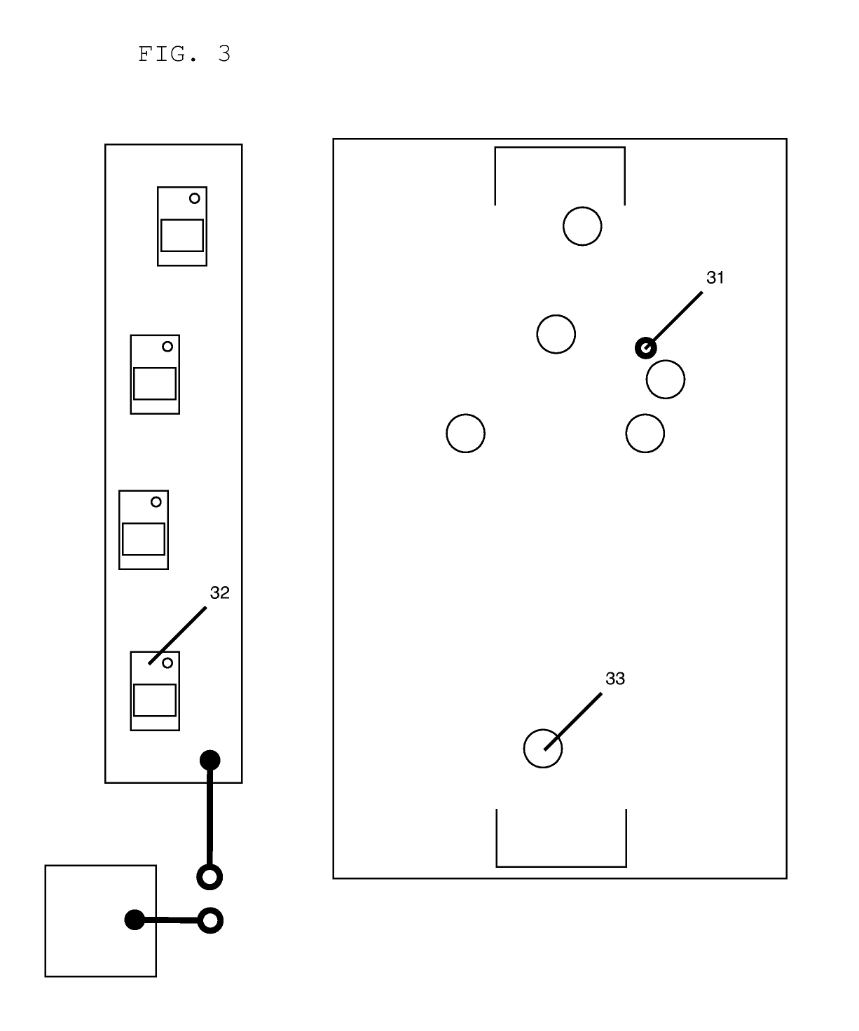

FIG. 3 illustrates a key tendency of video used in large sporting events. During game play, the action tends to follow the ball 31 and users 32 will tend to videotape the players that most interest them who may be in the action, while other users may follow players 33 not in the action. children but their children will tend to follow the ball. Software can evaluate the various streams and determine where the focal point of the event is by considering where the majority of cameras are pointed. It is possible that the software will make the wrong choice (outside the context of a soccer game, magic and misdirection being examples of this . . . where the eyes follow an empty hand believed to be full) but in most situations, the crowd-based data corresponding to what the majority is watching will yield the best edit/picture for later (or even live) viewing. On the subject of a live viewing, imagine that a viewer on the other end of a network can choose a perspective to watch live (or even recorded), but the default is one following the place where most people are recording.

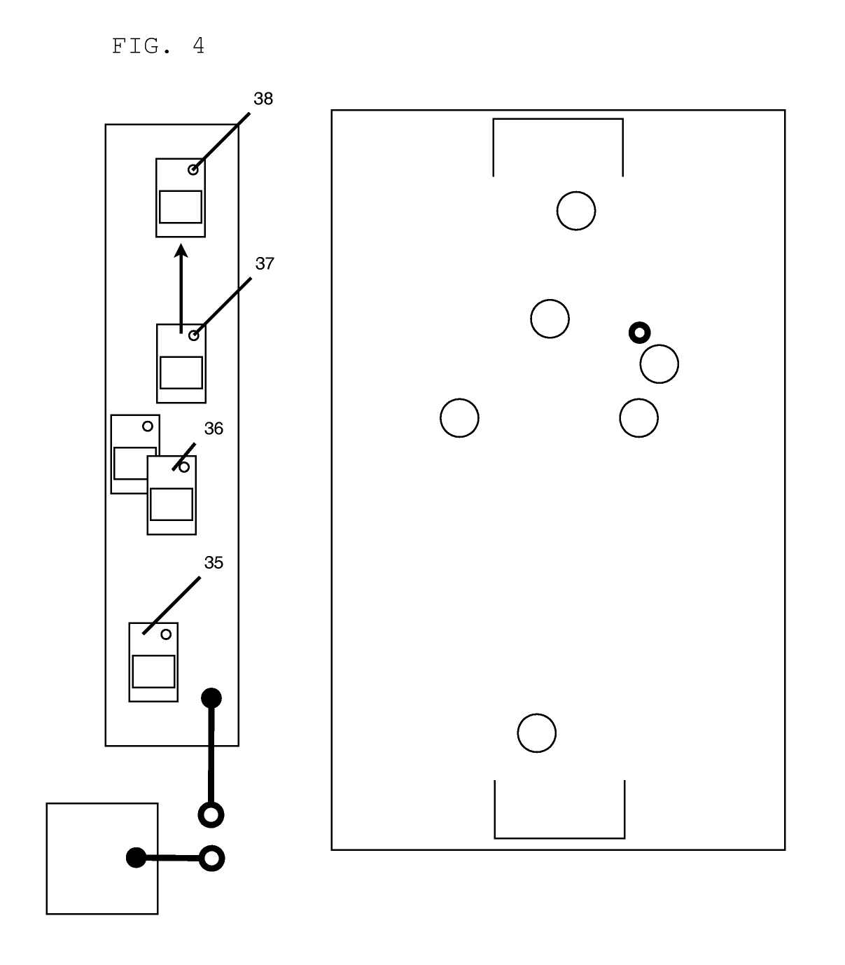

FIG. 4 illustrates the ability of the system to provide user feedback to improve the quality of the 3D model by helping the users shift their positions to improve triangulation. The system can identify a user at one end of the field 35 and a group of users in the middle of the filed 36. The system prompts one user 37 to move towards the other end of the field and prompts them to stop when they have moved into a better position 38, so that what is being recorded is optimal for all viewers, i.e., captures the most data.

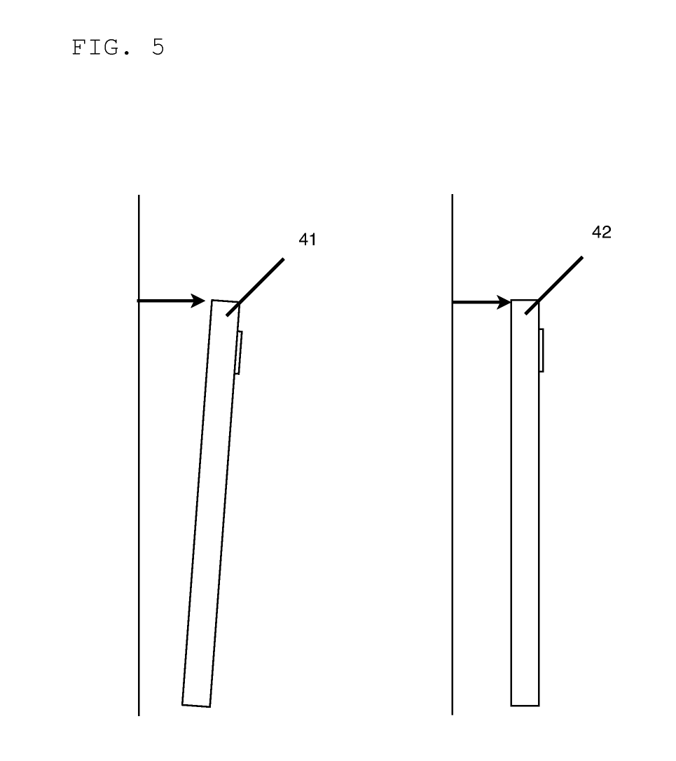

FIG. 5 illustrates one example of additional information that can be encoded as metadata in the video stream. One phone 41 is at a slight angle. Another phone 42 is being held completely flat. This information can be used as one factor in a large amount of information coming into the servers in order to improve the 3D map that is created of the field, as each phone captures different and improved data streams.

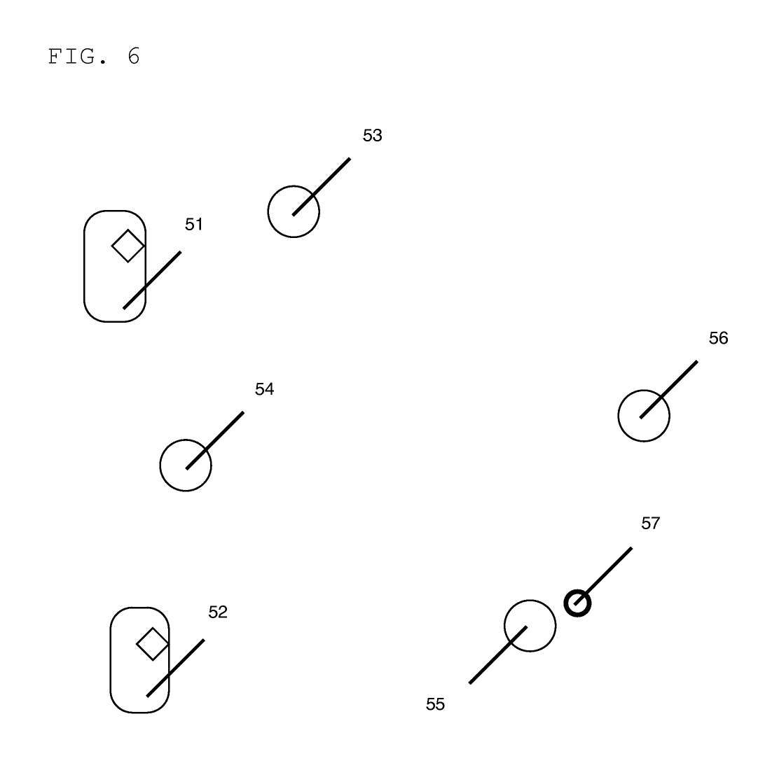

FIG. 6 illustrates a basic stereo phenomenon. There are two phones 51, 52 along the field. A spectator 54 is close to in between the two phones and both phones pick up sound evenly from their microphones. Another spectator 53 is much closer to one phone 51 and the phone that is further away 52 will receive a sound signal at a lower decibel level. The two phones may also be able to pick up stereo pan as the ball 57 is passed from one player 55 to another player 56. A playback system can use GPS locations of each user to balance the sounds to optimize the playback experience.

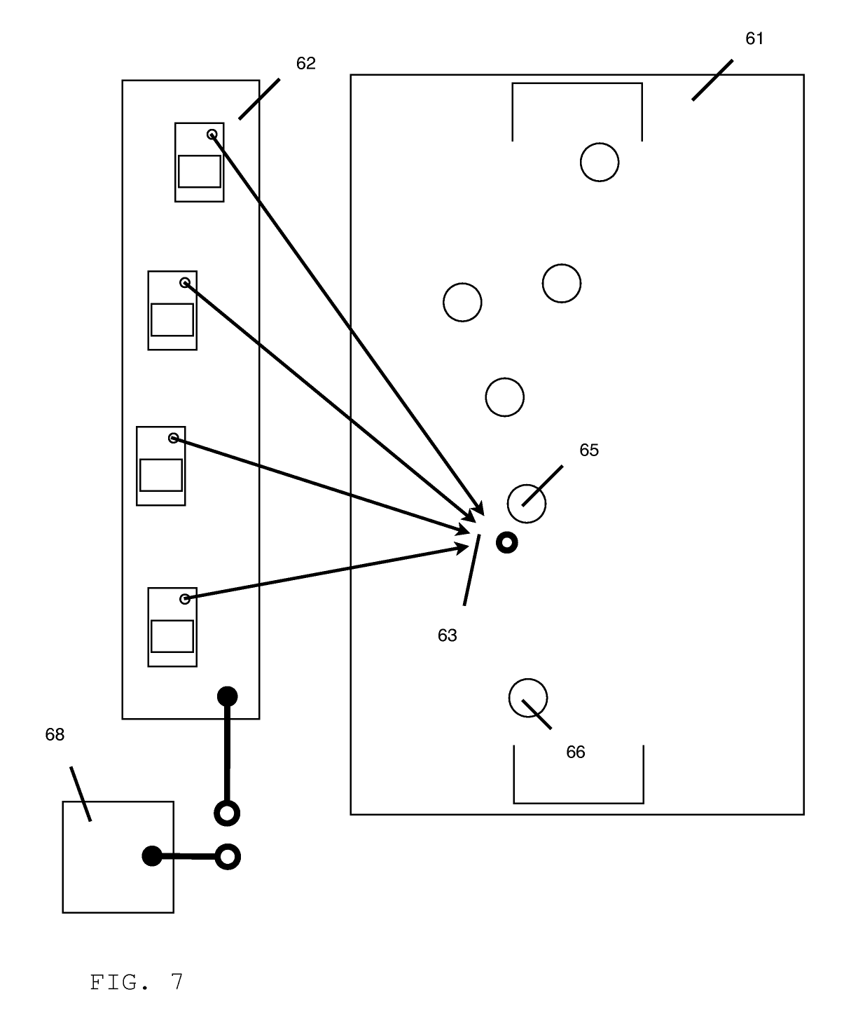

FIG. 7 illustrates multiple cameras 62 focused on a single point of action 63. All of this geometry along with the other sensor based metadata is transferred to the network based server where the content is analyzed and possibly used to prepare a virtual model representative of what can be sensed. This sensor-based metadata normally makes up less bandwidth than the traditional optical visual data (for example pixel color data) in photos and videos and provides the basis for wireframe/mesh models based on the received data. If a publicly accessible image of the soccer field 61 is available that can also be used along with the phones GPS data to improve the 3D image.

This composite 3D image may generate the most compelling features of this system. A user watching the feed at home add additional virtual cameras to the feed. These may even be point of view cameras tied to particular individual 65. The cameras may also be located to give an overhead view of the game.

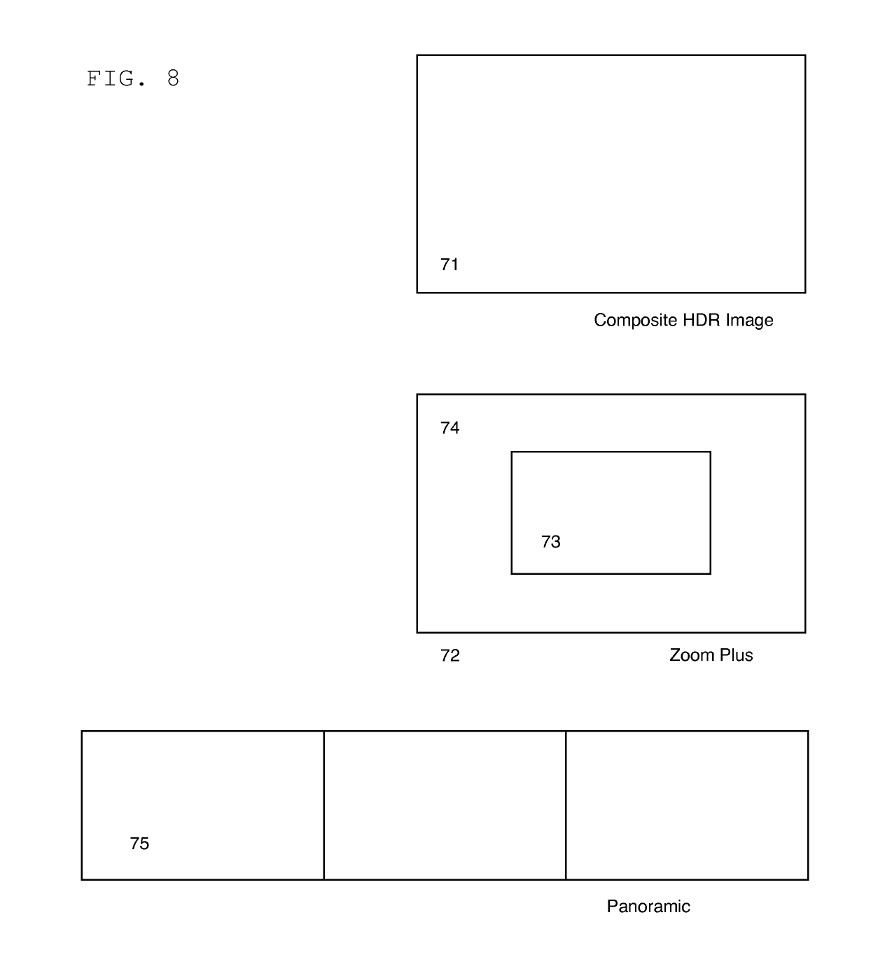

FIG. 8 illustrates other options available given access to multiple feeds and the ability to spread the feed over multiple GPUs and/or processors. A composite HDR image 71 can be created using multiple full resolution feeds to create the best possible image. It is also possible to add information beyond that captured by the original imager. This “zoom plus” feature 72 takes the original feed 73 and adds additional information from other cameras 74 to create a larger image. It is also possible, in a similar vane, to stitch together a panoramic video 75 covering multiple screens.

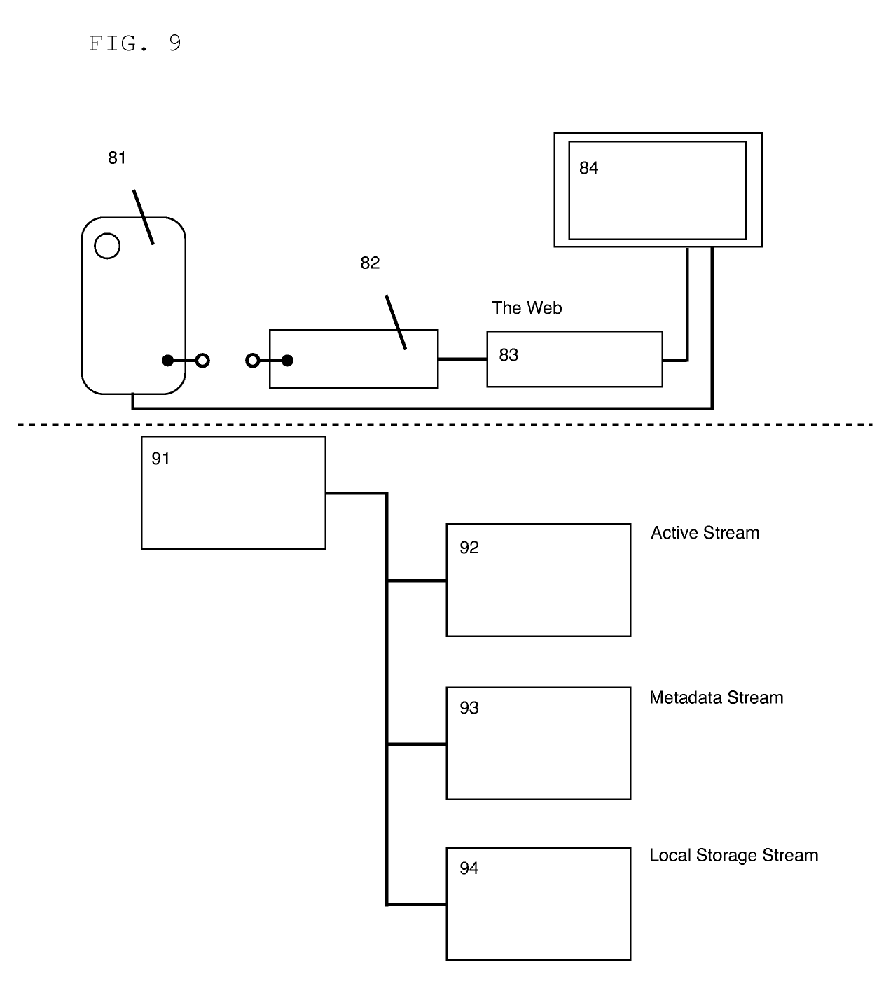

FIG. 9 displays the simple arrangement of a smartphone 81 linked to a server 82 with that server feeding an internet channel 83. The internet channel can be public or private and the phone serves this information in several different ways. The output shown is a display 84. For live purposes, the phone 81 feeds the video to the server 82, which distributes video over the internet 83 to a local device 84 for viewing. The viewer may record their own audio to use the feed audio and this too can be shared over the internet via the host server 82.

Later, the owner of the phone 81 may want to watch the video themselves. Assuming the users have a version of the video on the phone that carries the same network time stamp as the video on the server, when they connect their phone into a local display 84 for playback, they may be asked if they want to use any of the supplemental features available on the server 82. Although the server holds lower quality video than that stored on the phone, it is capable of providing features beyond those possible if the user only has the phone.

This is possible because the video frame 91 is handled and used in multiple ways on the phone 81 and at the server 82. The active stream 92 is encoded for efficient transfer over possibly crowded wireless networks. The encoding may be very good but the feed will not run at maximum resolution and frame rate. Additional data is included in the metadata stream 93, which is piggybacked on the live stream. The metadata stream is specifically tailored towards enabling functions on the server, such as the creation of 3D mesh models in an online video game engine and evaluating the related incoming streams to offer options such as those described in FIG. 7. The system may be able to evaluate all of the sensor based metadata information along a high structured video information such as edge detection, contrast mapping, and motion detection. The server may be able to use the metadata stream to develop finger prints and pattern libraries. This information can be used to create the rough vertex maps and meshes on which other video information can be mapped.

When the user hooks their smart phone/device 81 up to the local device 84 they connect the full resolution video 94 on the smartphone 81 to the video on the server 82. The software on the phone or the software on the local device will be able to integrate the information from these two sources.

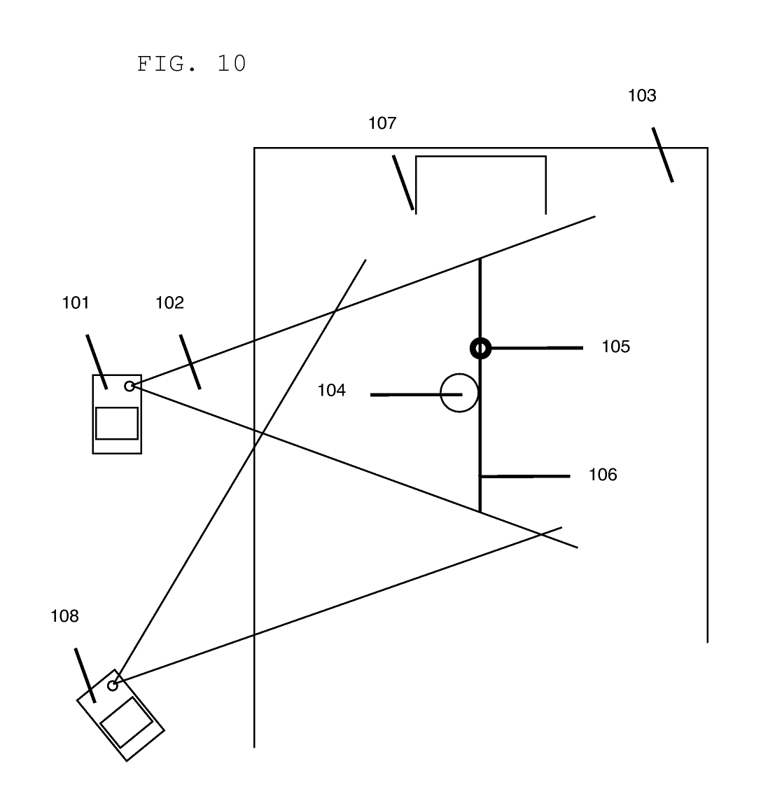

FIG. 10 illustrates at a simple level how a vertex map might be constructed. One user with a smartphone 101 makes a video of the game. The video has a specific viewing angle 102. There may be a documented image of the soccer pitch 103 available from an online mapping service. It is possible to use reference points in the image such as a player 104 or the ball 105 to create one layer 106 in the 3D mesh model. As additional information is added, this map may get richer and more detailed. Key fixed items like the goal post 107 may be included. Lines on the field and foreground and background objects will accumulate as the video is fed into the server.

A second camera 108 looking at the same action may provide additional 2D data which can be layered into the model. Additionally, the camera sensors may help to determine the relative angle of the camera. As fixed points in the active image area start to get fixed in the 3D model the system can reprocess the individual camera feeds to refine and filter the data.

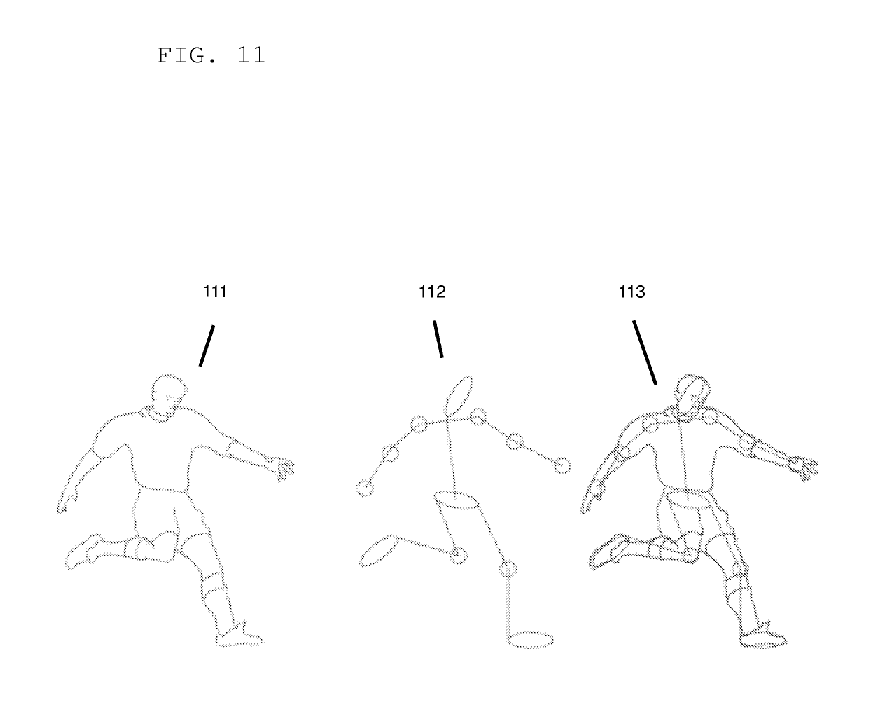

FIG. 11 illustrates the transition from the initial video stream to the skinned avatar in the game engine. A person in the initial video stream 111 is analyzed and skeletal information 112 is extracted from the video. The game engine can use the best available information to skin the avatar 113. This information can be from the video, from game engine files, from the player shots taken from the configuration mode, or from avatars available in the online software. A user may choose a FIFA star for example. That FIFA player may be mapped onto the skeleton 112.

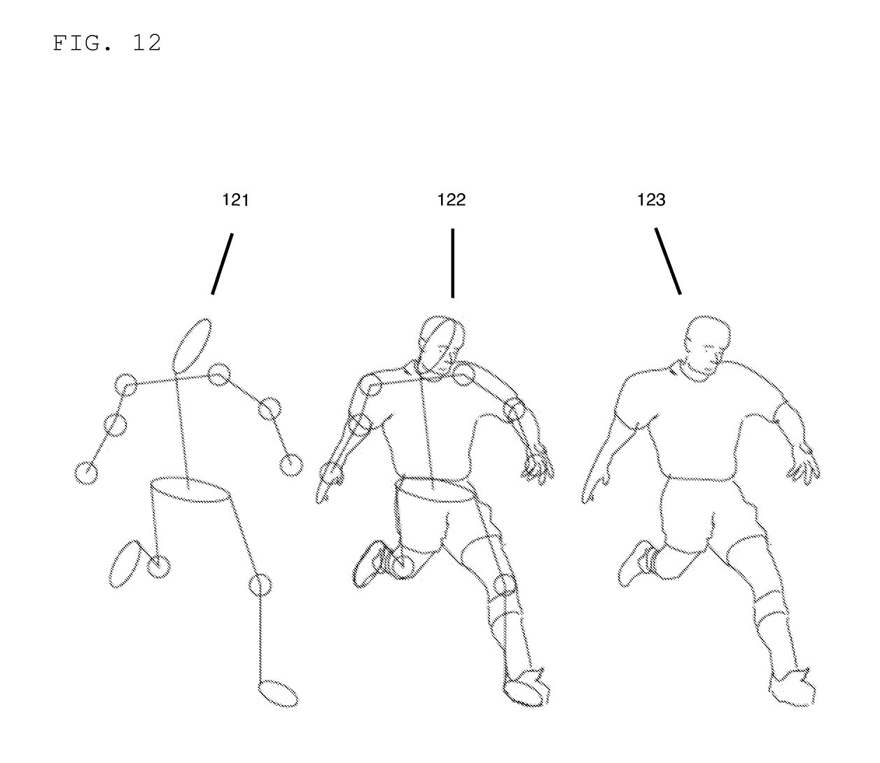

FIG. 12 illustrates a second angle and the additional information available in a second angle that is not available in the first images illustrated in FIG. 11. The skeleton 122 shows differences when compared to the skeleton 112 in FIG. 11 based on different perspective. The additional information helps to produce a better avatar 123.

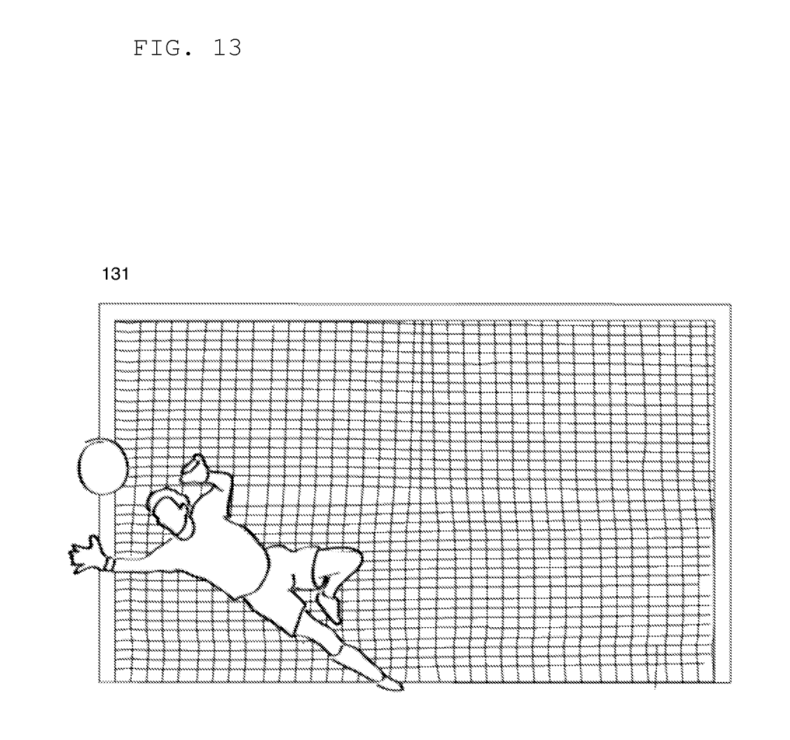

FIG. 13 illustrates a feature showing that once a three dimensional model has been created, additional virtual camera positions can be added. This allows a user to see a players eye view of a shot on goal 131.

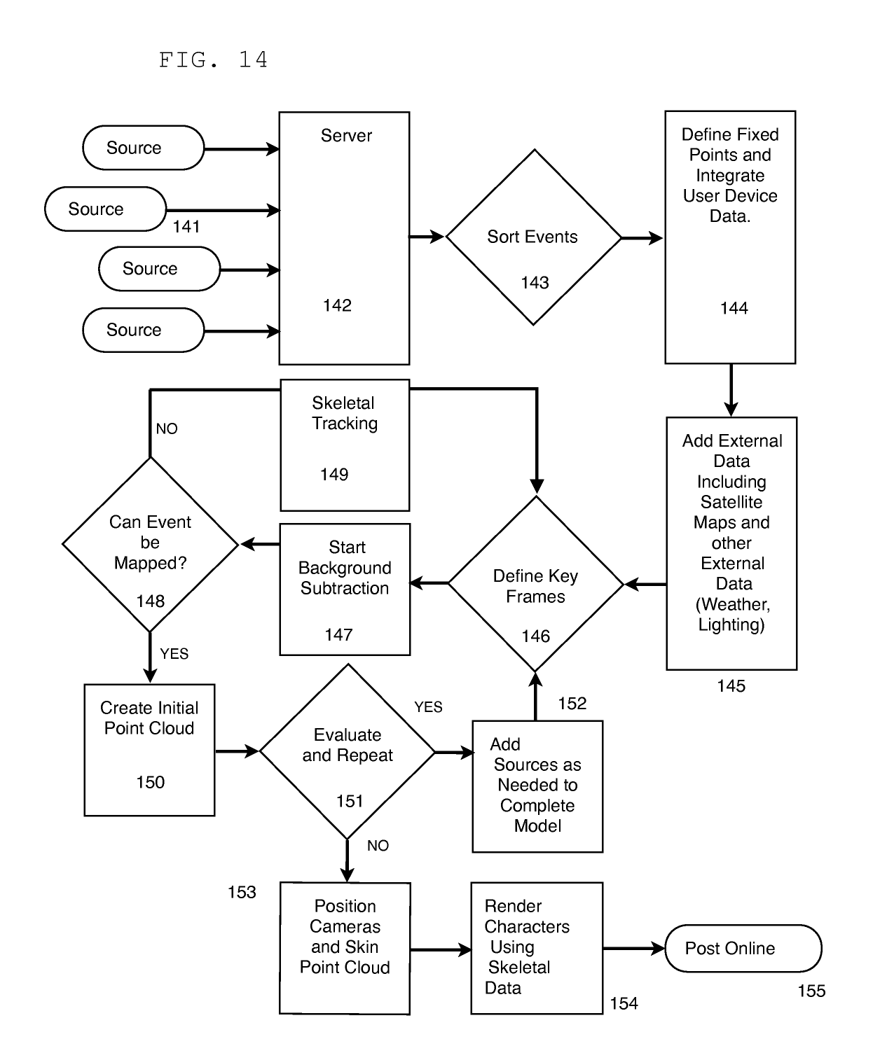

FIG. 14 describes the flow of data through the processing system that converts a locally acquired media stream and converts it into content that is available online in an entirely different form. The sources 141 may be aggregated in the server 142 where they may be sorted by event 143. This sorting may be based on time code and GPS data. In an instance where two users were recording images of players playing on adjacent fields, the compass data from the phone may indicate that the images were of different events. Once these events are sorted, the system may format the files so that all metadata is available to the processing system or server 144. The system may examine the location and orientation of the devices and any contextual sensing to identify the location of the users. At this point external data 145 may be incorporated into the system. Such data can determine the proper orientation of shadows or the exact geopyhysical location of a goal post. The nature of such a large data system is that data from each game at a specific location will improve the users experience on the next game. User characteristics such as repeatedly choosing specific seats at a field may also feed into improved system performance over time. The system will sort through these events and build initial masking and depth analysis based on pixel flow (movement in the frame) of individual cameras, correcting for camera motion. In this analysis, it may look for moving people and perform initial skeletal tracking as well as ball location.

The system may tag and weight points based on whether they were hard data from the frame or interpolated from pixel flow. It may also look for static positions, like trees and lamp posts that may be used as trackers. In this process, it may deform all images from all cameras so that they were consistent, based on camera internals. The system evaluates the data by searching all video streams identified for a specific event, looking for densely covered scenes. These scenes may be used to identify key frames 146 that form the starting point for the 3D analysis of the event. The system may start at the points in the event at which there was the richest dataset among all of the video streams and then proceed to work forward and backward from those points. The system may then go through frame by frame, choosing a 1st image to work from to start background subtraction 147. The image may be chosen because it was at the center of the baseline and because it had a lot of activity.

The system may then choose a second image from either the left or right of the baseline that was looking at the same location and had similar content. It may perform background subtraction on the content. The system may build depth maps of knocked out content from the two frames, performing point/feature mapping using the fact that they share the same light source as a baseline. The location of features may be prioritized based on initial weighting from pixel flow analysis in step one. When there is disagreement between heavily weighted data 148, skeletal analysis may be performed 149, based on pixelflow analysis. The system may continue this process comparing depthmaps and stitching additional points onto the original point cloud. Once the cloud was rich enough, the system may then perform a second pass 150, looking at shadow detail on the ground plane and on bodies to fill in occluded areas. Throughout this process, the system may associate pixel data, performing nearest neighbor and edge detection across the frame and time. Pixels may be stacked on the point cloud. The system may then take an image at the other side of the baseline and perform the same task 151. Once the point cloud is well defined and 3D skeletal models created, these may be used to run an initial simulation of the event. This simulation may be checked for accuracy against a raycast of the skinned pointcloud. If filtering determined that the skinning was accurate enough or that there were irrecoverable events within the content, editing and camera positioning may occur 153. If key high-speed motions, like kicks, were analyzed the may be replaces with animated motion. The skeletal data may be skinned with professionally generated content, user generated content or collapsed pixel clouds 154. And this finished data may be made available to users 155.

The finished data can be made available in multiple ways. For example, a user can watch a 3D video online based on the video stream they initially submitted. A user can watch a 3D video of the game based on the edit decisions of the system. A user can order a 3D video of the game on a single write video format. A user can use a video game engine to navigate the game in real time watching from virtual camera positions that have been inserted into the game. A user can play the game in the video game engine. A soccer game may be ported into the FIFA game engine, for example. A user can customize the game swapping in their favorite professional player in their position or an opponents position.

If a detailed enough model is created it may be possible to use highly detailed prerigged avatars to represent players on the field. The actual players faces can be added. This creates yet another viewing option. Such an option may be very good for more abstracted uses of the content such as coaching.

While soccer has been used as an example throughout, other sporting events could also be used. Other applications for this include any event with multiple camera angles including warfare or warfare simulation, any sporting event, and concerts.

While the present disclosure has been described with respect to a limited number of embodiments, those skilled in the art, having benefit of this disclosure, will appreciate that other embodiments may be devised which do not depart from the scope of the disclosure as described herein.

What is claimed is:

1. A system for creating images for display comprising:
first and second recording devices comprising sensors that record sensor based data that comprises at least location data; and
a server that receives the sensor based data from the recording devices;
wherein the server, based on sensor based data from the recording devices creates a virtual representation model for display.

2. The system of claim 1, wherein the location data comprises GPS information.

3. The system of claim 1, wherein the sensor based data comprises accelerometer data.

4. The system of claim 1, wherein the sensor based data comprises sound signal data.

5. The system of claim 1, wherein the sensor based data comprises edge detection data.

6. The system of claim 1, wherein the sensor based data does not include pixel color data.

7. The system of claim 1, wherein the sensor based data comprises contrast data.

8. The system of claim 1, wherein the sensor based data comprises motion information data.

9. The system of claim 1, wherein the server uses the sensor based data to create the model from a wireframe image.

10. The system of claim 1, wherein the server includes a video game engine and the sensor based data from the first recording device and second recording device is mapped into the video game engine.

11. The system of claim 10, wherein a user can move the recording device's positions within the video game engine to create new perspectives.

12. The system of claim 1, wherein sensor based data comprises sound data and the server combines the sound data to create a sound output.

13. The system of claim 1, wherein the server compares sensor based data from a plurality of recording devices to determine location of the recording devices and the server creates a digital environment based on image data from the plurality of recording devices.

14. The system of claim 1, wherein the model comprises a point cloud of vertices.

15. The system of claim 1, wherein the recording devices are mobile phones with an application installed that allows for communication of sensor based data to the server.

16. The system of claim 1, wherein the model provides an interactive virtual reality experience for a user.

17. The system of claim 1, wherein the virtual reality experience is a game.

18. A method for creating displayable video from multiple recordings comprising:
creating a sensor mesh wherein the sensors record sensor based data and video from multiple perspectives on multiple sensors;
comparing the multiple recorded videos and sensor based data to one another on a server networked to the multiple sensors; and
based on the comparison, creating a map model of a single composite video stream that is comprised of sensor based data from the multiple perspectives from the multiple sensors.

19. The method of claim 18, wherein based on the comparison, creating multiple video streams for display.

20. The method of claim 18, wherein the multiple video streams comprise multiple perspectives.
